(19) United States
(12) Patent Application Publication
(10) Pub. No.: US 2025/0356388 A1
(43) Pub. Date: Nov. 20, 2025

(54) METHOD OF AND SYSTEM FOR PROVIDING PERSONALIZED RECOMMENDATIONS IN REAL-TIME

(71) Applicant: POLYMATIKS LTD., Stouffville (CA)

(72) Inventors: Hichem Fadali, Stouffville (CA); Victor Daniel Zurkowski, Toronto (CA); Pedro Ivo Teixeira Soares, Montes Claros (BB)

(73) Assignee: POLYMATIKS LTD., Toronto (CA)

(21) Appl. No.: 18/664,899

(22) Filed: May 15, 2024

(51) Int. Cl. G06Q 30/0207; G06Q 30/0601

(52) U.S. Cl. CPC G06Q 30/0224; G06Q 30/0631

(57) ABSTRACT

There are provided methods, systems and non-transitory storage mediums for providing personalized item recommendations to a user in real-time. Data related to items on a web resource and as user data comprising profiles, preferences, and past interactions with items of a plurality of users are received. Personalized strategies and constraints for a second set of items are received. An objective function representing optimization goals is also received. Using an inference engine, user behavior of a plurality users is inferred based on the received data. In real-time, user interactions of a user with the web resource is received, and personalized item recommendations are generated by a personalized recommendation engine for the user based on the user interaction, inferred user behavior, offer strategies, and the objective function. The personalized item recommendations, along with discount types and time periods, are transmitted to the user's device in real-time.

### CROSS-REFERENCE TO RELATED APPLICATIONS

None.

### FIELD

The present technology relates to computer-implemented personalized recommendations in general and more specifically to methods, systems, and non-transitory storage mediums for generating and providing personalized recommendations to users of a web resource in real-time.

### BACKGROUND

Offers are marketing instruments that involve providing price discounts on items. Retailers and manufacturers widely distribute offers through various channels for multiple purposes, such as price sensitivity testing, demand generation, increasing sales, retaining customers, driving store traffic, encouraging new product trials, triggering brand switching, enhancing loyalty, and promoting loyalty program membership sign-ups and renewals.

Traditionally, offers have been distributed indiscriminately through direct mail, in-pack or on-pack promotions, handouts, magazines, free standing inserts, newspapers, and the internet. However, data-driven retailers and online merchants are now leveraging extensive sales and marketing databases to strategically target offers to specific markets, user segments, and even individual users. This shift towards personalized execution channels aims to enhance the relevance and impact of the offers.

Recommendations are widely distributed through different channels and serve diverse purposes, including but not limited to personalized suggestions, tailored advice, targeted content delivery, and customized experiences. The goal is to leverage available data and insights to enhance the relevance and impact of recommendations for the intended recipients.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

Developers of the present technology have appreciated that the aim behind personalized and real-time recommendation campaigns is to maximize relevance and achieve desired outcomes, such as improving user satisfaction, increasing engagement, fostering loyalty, or optimizing decision-making processes. However, it is essential to acknowledge that poorly designed recommendation strategies can carry risks, including potential negative impacts on user experience or outcomes.

One or more implementations of the present technology have been developed based on developers' appreciation that by leveraging data-driven insights, personalized execution channels, and real-time offer generation using machine learning models enhances the impact and effectiveness of offer campaigns. Through targeted and optimized recommendation, content providers and retailers can mitigate risks and achieve better outcomes, including increased sales, improved customer loyalty, and enhanced profitability.

Thus, one or more implementations of the present technology are directed to methods, systems, and non-transitory storage mediums for generating and providing personalized recommendations to users of a web resource in real-time.

In accordance with a broad aspect of the present technology, there is provided a method for providing personalized item recommendations to a given user in real-time, the method being executed by at least one processor. the method comprising: receiving data associated with a plurality of items provided on a given web resource associated with a given entity, receiving user data indicative of a respective behavior of a plurality of users, the user data comprising respective user profiles, respective user preferences, and respective past user interactions with a first set of items, receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items, receiving an objective function associated with the entity, the objective function being representative of at least one objective to optimize for the entity, generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items, receiving, in real-time, from a client device associated with a given user of the plurality of users, a user interaction with the given web resource, generating, in real-time by an personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period, and transmitting, in real-time, to the client device, the personalized items recommendations with the respective type of discount and the respective time period.

In one or more implementations of the method, the user interaction comprises at least one of: searching for a given item of the second set of items, viewing the given item and selecting the given item.

In one or more implementations of the method, the method further comprises: caching, in a non-transitory storage medium operatively connected to the at least one processor, the personalized item recommendation associated with the respective identifier, the respective type of discount and the respective time period, receiving a further user interaction, the further user interaction comprising an indication of the respective identifier of the personalized item recommendation, receiving, from the non-transitory storage medium, based on the further user interaction, the cached personalized item recommendation, comparing the respective time period of the cached personalized item recommendation to a time difference between the user interaction and the further user interaction, and in response to the time difference being less than the respective time period: providing a confirmation of the personalized item recommendation to the client device.

In one or more implementations of the method, the respective past user interactions comprise at least one of: past purchased items and past viewed items.

In one or more implementations of the method, the personalized recommendation engine is configured to determine and solve conflicts between personalized offer strategies.

In one or more implementations of the method, the personalized item recommendations comprise at least one stackable item associated with an aggregated discount, the aggregated discount being a combination of two respective adjusted discounts.

In one or more implementations of the method, the respective type of discount for the personalized item recommendation comprises at least one of: an adjusted price and a reward.

In one or more implementations of the method, the method further comprises: receiving another user interaction, the user interaction confirming the personalized item recommendation, and storing the user interactions, the personalized item recommendation and the respective type of discount for further training of the personalized recommendation engine.

In one or more implementations of the method, the personalized recommendation engine comprises at least one of: neural networks, Kolmogorov-Arnold networks, regression trees (e.g., gradient-boosted trees models), recommender systems, Markov processes, Monte Carlo simulations, and double debiased machine learning models.

In accordance with a broad aspect of the present technology, there is provided a system for providing personalized item recommendations to a given user in real-time. The system comprises: a non-transitory storage medium storing computer-readable instructions thereon, and at least one processor operatively connected to the non-transitory storage medium. The at least one processor, upon executing the computer-readable instructions, is configured for: receiving data associated with a plurality of items provided on a given web resource associated with a given entity, receiving user data indicative of a respective behavior of a plurality of users, the user data comprising respective user profiles, respective user preferences, and respective past user interactions with a first set of items, receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items, receiving an objective function associated with the entity, the objective function being representative of at least one objective to optimize for the entity, generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items, receiving, in real-time, from a client device associated with a given user of the plurality of users, a user interaction with the given web resource, generating, in real-time by an personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period, and transmitting, in real-time, to the client device, the personalized items recommendations with the respective type of discount and the respective time period.

In one or more implementations of the system, the user interaction comprises at least one of: searching for a given item of the second set of items, viewing the given item and selecting the given item.

In one or more implementations of the system, the at least one processor is further configured for: caching, in a non-transitory storage medium operatively connected to the at least one processor, the personalized item recommendation associated with the respective identifier, the respective type of discount and the respective time period, receiving a further user interaction, the further user interaction comprising an indication of the respective identifier of the personalized item recommendation, receiving, from the non-transitory storage medium, based on the further user interaction, the cached personalized item recommendation, comparing the respective time period of the cached personalized item recommendation to a time difference between the user interaction and the further user interaction, and in response to the time difference being less than the respective time period: providing a confirmation of the personalized item recommendation to the client device.

In one or more implementations of the system, the respective past user interactions comprise at least one of: past purchased items and past viewed items.

In one or more implementations of the system, the personalized recommendation engine is configured to determine and solve conflicts between personalized offer strategies.

In one or more implementations of the system, the personalized item recommendations comprise at least one stackable item associated with an aggregated discount, the aggregated discount being a combination of two respective adjusted discounts.

In one or more implementations of the system, the respective type of discount for the personalized item recommendation comprises at least one of: an adjusted price and a reward.

In one or more implementations of the system, the at least one processor is further configured for: receiving another user interaction, the user interaction confirming the personalized item recommendation, and storing the user interactions, the personalized item recommendation and the respective type of discount for further training of the personalized recommendation engine.

In one or more implementations of the system, the personalized recommendation engine comprises at least one of: neural networks, Kolmogorov-Arnold networks, regression trees (e.g., gradient-boosted trees models), recommender systems, Markov processes, Monte Carlo simulations, and double debiased machine learning models.

In accordance with a broad aspect of the present technology, there is provided a non-transitory storage medium storing computer-readable instructions thereon. The computer-readable instructions, upon being executed by at least one processor are for causing: receiving data associated with a plurality of items provided on a given web resource associated with a given entity, receiving user data indicative of a respective behavior of a plurality of users, the user data comprising respective user profiles, respective user preferences, and respective past user interactions with a first set of items, receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items, receiving an objective function associated with the entity, the objective function being representative of at least one objective to optimize for the entity, generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items, receiving, in real-time, from a client device associated with a given user of the plurality of users, a user interaction with the given web resource, generating, in real-time by an personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period, and transmitting, in real-time, to the client device, the personalized items recommendations with the respective type of discount and the respective time period.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “computing device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client computing devices, associated with one or more users, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting implementations of the present technology.

FIG. 2 depicts a schematic diagram of a communication system in accordance with one or more non-limiting implementations of the present technology.

FIG. 3 illustrates a schematic diagram of inputs and outputs of the inference procedure and the real-time personalized item recommendation procedure in accordance with one or more non-limiting implementations of the present technology.

FIG. 4 illustrates a non-limiting example of personalized item recommendations provided to a user in a user interface in accordance with non-limiting implementations of the present technology.

FIGS. 5A and 5B illustrate two further non-limiting example of the same personalized item recommendations provided to two different users in a user interface, where the adjusted prices for the personalized item recommendations are different in accordance with one or more non-limiting implementations of the present technology.

FIGS. 6A and 6B illustrate a flowchart of a method of providing personalized recommendations to a user in real-time in accordance with one or more non-limiting implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting implementations of the present technology, the processor may be a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computing Device

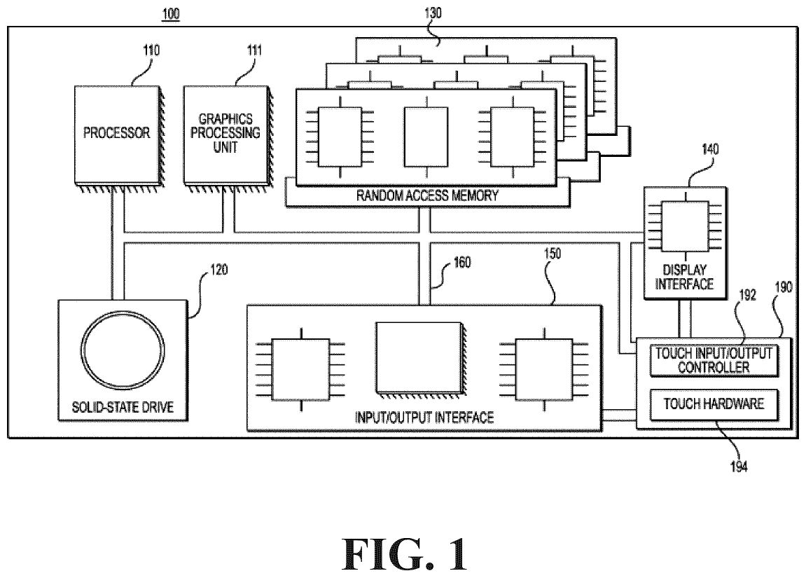

Referring to FIG. 1, there is shown a computing device 100 suitable for use with some implementations of the present technology, the computing device 100 comprising various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computing device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more implementations, the touchscreen 190 is the display. The touchscreen 190 may equally be referred to as a screen 190. In the implementations illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more implementations, the input/output interface 150 may be connected to a keyboard (not shown), a mouse (not shown) or a trackpad (not shown) allowing the user to interact with the computing device 100 in addition or in replacement of the touchscreen 190.

According to implementations of the present technology, the solid-state drive 120 stores program instructions suitable for being loaded into the random-access memory 130 and executed by the processor 110 and/or the GPU 111 for providing personalized recommendations to users in real-time. For example, the program instructions may be part of a library or an application.

The computing device 100 may be implemented as a server, a desktop computer, a laptop computer, a tablet, a smartphone, a personal digital assistant or any device that may be configured to implement the present technology, as it may be understood by a person skilled in the art.

### System

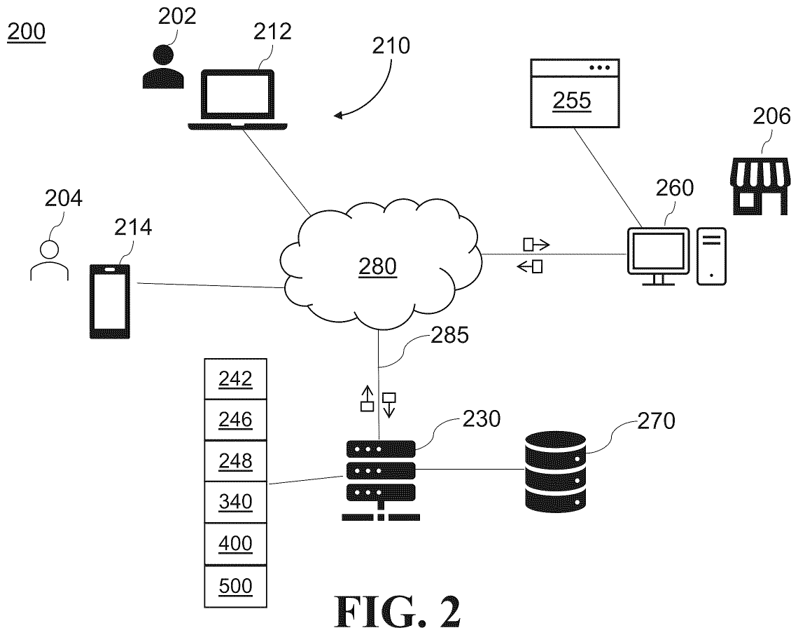

Referring to FIG. 2, there is shown a schematic diagram of a communication system 200, the communication system 200 being suitable for implementing one or more non-limiting implementations of the present technology. It is to be expressly understood that the communication system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the communication system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the communication system 200 may provide in certain instances simple implementations of the present technology, and that where such is the case they have been presented in this manner as an aid to understanding. As persons skilled in the art would understand, various implementations of the present technology may be of a greater complexity.

In one or more implementations, the communication system 200 is an example of a communication system used to provide personalized recommendations to users in real-time. The communication system 200 performs inference of user behavior on a web resource with regard to items and performs real-time personalized item recommendations in response to interactions from each user on the web resource, as explained hereinafter.

The communication system 200 comprises inter alia a plurality of client devices 210, a server 230, one or more entity client devices 260, and a database 270 communicatively coupled over a communications network 280.

### Client Device

The communication system 200 comprises a plurality of client devices 210.

While only two client devices are shown in FIG. 2 (first client device 212 associated with first user 202 and second client device 214 associated with second user 204), it should be understood that there may be dozens, hundreds or thousands of client devices 210, each associated with at a respective user.

Each client device 212, 214 is associated with respective user 202, 204. As such, a given client device 212, 214 can sometimes be referred to as a “computing device”, “end user device” or “client computing device”.

Each client device 212, 214 comprises one or more components of the computing device 100 such as one or more single or multi-core processors collectively represented by processor 110, the graphics processing unit (GPU) 111, the solid-state drive 120, the random-access memory 130, the display interface 140, and the input/output interface 150.

It will be appreciated that each client device 212, 214 may be implemented respectively as a server, a desktop computer, a laptop, a smartphone, a virtual reality (VR) headset and the like.

In one or more implementations, each client device 212, 214 is configured to execute a browser application (not shown). The purpose of the given browser application is to enable the given user 202, 204 to access one or more web resources. How the given browser application is implemented is not particularly limited. Non-limiting examples of the given browser application that is executable by the client device 210 include Google™ Chrome™, Mozilla™ Firefox™, Microsoft™ Edge™, and Apple™ Safari™.

Each user 202, 204 may access web resources associated with respective entities via the client device 212, 214 such as the given web resource 255 associated with entity 205. It will be appreciated that the given web resource 255 may be accessed via the browser application, or via one or more software applications (“apps”) executed by the client device 210.

In one or more implementations, each user 202, 204 has previously registered an account with the given web resource and set up a profile.

It should be noted that depending on how client device 212, 214 is implemented, a given user 202, 204 may perform navigation using one or more of visual interfaces (e.g., screens, AR or VR interfaces), audio interfaces (e.g. voice activated systems), text-based interfaces, gesture-based interfaces, haptic interfaces and brain-computer interfaces.

### Entity Client Device

The communication system 200 comprises one or more entity client devices 260 (only one shown in FIG. 2) associated with a given respective entity 206.

The given entity 206 provides an entity web resource 255. The entity web resource 255 may be hosted on the entity client device 260 and/or on other computing devices (e.g., server or cloud service (not shown)).

The given entity 206 may include an organization, individual, or business that manages, operates, and/or owns the web resource 255. The given entity 206 may be responsible for the content, transactions, and overall management of the web resource 255, and may engage in activities such as marketing, sales, customer service, and product delivery. The given entity 206 may correspond to sole proprietors, partnerships, corporations, non-profits, or governmental bodies that utilize the web resource 255 as a channel for interaction with users.

The given entity 206 provides items on the web resource 255. Non-limiting examples of items may include, but are not limited to one or more of: e-commerce goods, services such as restaurant reservations and financial products, and content such as books, movies, music, educational courses, fitness programs, and travel suggestions.

The given entity web resource 255 may be, as a non-limiting example, a website. In one or more implementation, the web resource 255 may have a backend a front-end infrastructure (not shown), as known in the art. The backend infrastructure primarily consists of a database management system designed to store comprehensive details such as product information, user data, inventory, and transaction histories. The front-end interface is developed using HTML, CSS, and JavaScript, which are employed to create the visible part of the website where users interact. This includes elements like product pages, search bars, and navigation menus.

In the context of the present technology, users access the web resource 255 via one of the plurality of client devices 210 and perform user interactions thereon, which may include navigating, viewing, purchasing or consuming content provided by the web resource 255.

In one or more implementations, each user 202, 204 accesses the given web resource 255 via a graphical user interface displayed on respective client device 212, 214. Each user 202, 204 may navigate through various sections of the given web resource 255 using navigational controls, such as menus, links, and buttons, which are placed to enhance user experience and facilitate easy access to different categories of content or products. As the user 202, 204 user interacts with the web resource, selections of items for purchase or consumption can be made. Each selected item can be added to a virtual shopping cart, a feature implemented to track items intended for purchase or consumption. The user 202, 204 may adjust quantities, remove items, or review the cart's contents before proceeding. Upon final review, the user 202, 204 can execute a purchasing sequence through an integrated checkout system, where payment and delivery information is securely entered and processed to complete the transaction.

The given entity web resource 255 is configured to communicate data to the server 230 or other computing devices, including retailer data, user behavior data, personalized offer strategies, and third-party data, as explained hereinafter.

### Server

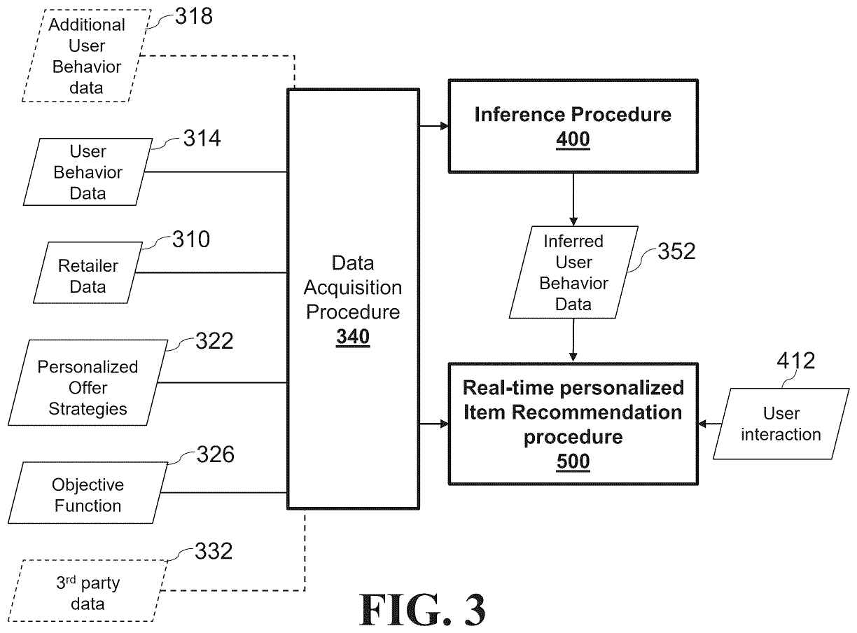

In one or more implementations, the server 230 is configured to execute inter alia: (i) one or more inference engines 242; (ii) one or more personalized recommendation engines 246; (iii) one or more cache engines 248; (iii) one or more data acquisition procedure(s) 340 (explained hereinbelow with reference to FIG. 3); (iv) one or more inference procedures 400 using the one or more inference engines 242 (explained hereinbelow with reference to FIG. 3); and (v) one or more real-time personalized item recommendation procedures 500 using the one or more personalized recommendation engine 246.

How the server 230 is configured to do so will be explained in more detail herein below.

It will be appreciated that the server 230 can be implemented as a computer server and may comprise at least some of the features of the computing device 100 shown in FIG. 1. In a non-limiting example of one or more implementations of the present technology, the server 230 is implemented as a server running an operating system (OS). Needless to say, that the server 230 may be implemented in any suitable hardware and/or software and/or firmware or a combination thereof. In the disclosed non-limiting implementation of present technology, the server 230 is a single server. In one or more alternative non-limiting implementations of the present technology, the functionality of the server 230 may be distributed and may be implemented via multiple servers (not shown).

The implementation of the server 230 is well known to the person skilled in the art. However, the server 230 comprises a communication interface (not shown) configured to communicate with various entities (such as the database 270, for example and other devices potentially coupled to the communication network 280) via the communication network 280. The server 230 further comprises at least one computer processor (e.g., the processor 110 of the computing device 100) operatively connected with the communication interface and structured and configured to execute various processes to be described herein.

The server 230 executes one or more inference engines 242 and one or more personalized recommendation engines 246.

In one or more implementations, the one or more inference engines 242 may include one or more of: large language models (LLMs), linear regression models, logistic regression models, Poisson models, negative binomial models, clustering algorithms (e.g., K-means, Gaussian mixture models), and econometric time series. The one or more inference engines 242 may be trained on training data to update their respective model parameters.

It will be appreciated that linear regression models utilize coefficients for each independent variable and an intercept, the constant term indicating the expected mean value when predictors are zero. Logistic regression models share a similar structure, with coefficients representing the log odds of the dependent binary outcome and an intercept for baseline log odds. Poisson models use a lambda parameter as the rate of events per interval and coefficients for predictor influence. Negative binomial models include a number of successes until experiment cessation, probability of success, and coefficients affecting event counts.

Econometric time series typically involve ARIMA parameters (p, d, q) for auto-regressive terms, degrees of differencing, and moving averages, along with seasonal components for periodic variations. Large language models feature numerous parameters such as weights, biases, layer norms, and attention heads in transformer architectures. Neural networks are defined by weights and biases in each layer, adjusted during training, and activation functions that output node responses based on inputs.

In one or more implementations, the one or more personalized recommendation engines 246 may include one or more of: neural networks, Kolmogorov-Arnold networks, regression trees (e.g., gradient-boosted trees models), recommender systems, Markov processes, Monte Carlo simulations, and double debiased machine learning models.

Neural networks are characterized by parameters such as weights and biases, which are adjusted during training, a learning rate that controls the magnitude of these adjustments, and various activation functions that dictate the output at each node. Kolmogorov-Arnold networks include function terms which are individual functions within the model, weights assigned to each function to signify their importance, and feature interactions that model the interplay between inputs. Regression trees, including gradient-boosted trees models, consist of a hierarchical tree structure of nodes, branches, and leaves, with specific split points or criteria determining data segmentation at each node, and a learning rate that moderates the contribution of each tree in boosting techniques.

Recommender systems utilize user and item embeddings to represent characteristics, incorporate bias terms to adjust for inherent user and item biases, and employ regularization parameters to avoid overfitting. Markov processes are defined by transition probabilities that depict the likelihood of moving from one state to another, a set of possible states, and initial state probabilities indicating the starting point of the system. Monte Carlo simulations rely on random input parameters to replicate system randomness, a defined number of simulations to enhance result robustness, and convergence criteria to determine solution stability. Lastly, double debiased machine learning involves nuisance parameters secondary to the main estimation, influence functions to mitigate bias, and regularization techniques to manage the complexity of estimating these nuisance parameters.

### Cache Engines

The server 230 executes one or more cache engines 248.

The one or more cache engines 248 are configured to cache or temporarily stores data objects transmitted over the communication network 290 to improve performance and reduce network traffic. The one or more cache engines 248 cache engine determines when and which data objects should be cached based on predefined rules or policies by operators of the present technology. When a client device (e.g., client devices 210 or entity client devices 260) requests a data object, the one or more cache engines 248 are configured to first checks if that object is already stored in its cache memory. If the object is found (cache hit), the cache engine retrieves it from the cache and returns it to the client, avoiding the need to fetch it from the original computing device over the communication network 280. If the requested object is not in the cache (cache miss), the cache engine forwards the request to the original computing device. When the server 230 responds with the requested object, the one or more cache engines 248 stores a copy of that object in its cache memory before delivering it to the client device. This cached copy can then be served for subsequent requests for the same object. The one or more cache engines 248 may be configured to manage the cached objects using techniques such as, but not limited to, expiration policies to remove stale objects based on time-to-live (TTL) values or other freshness criteria, eviction policies like least recently used (LRU) to remove objects when the cache is full. The one or more cache engines 248 are configured to use consistency mechanisms to ensure cached objects are synchronized with updates on the original server.

In one or more implementations, the one or more cache engines 248 are configured to support different caching strategies like read-through caching (fetch from cache first, then server), write-through caching (update cache first, then server), and write-behind caching (update cache first, then server after a delay). It will be appreciated that by caching frequently accessed data objects in memory, the one or more cache engines 248 reduce bandwidth usage, decreases server load, and improves response times for clients accessing that data over the network.

### Database

One or more databases 270 (only one shown in FIG. 2) are communicatively coupled to the server 230 but, in one or more alternative implementations, the database 270 may be directly coupled to the server 230 without departing from the teachings of the present technology. Although the database 270 is illustrated schematically herein as a single entity, it will be appreciated that the database 270 may be configured in a distributed manner, for example, the database 270 may have different components, each component being configured for a particular kind of retrieval therefrom or storage therein.

The database 270 may be a structured collection of data, irrespective of its particular structure or the computer hardware on which data is stored, implemented or otherwise rendered available for use. The database 270 may reside on the same hardware as a process that stores or makes use of the information stored in the database 270 or it may reside on separate hardware, such as on the server 230. The database 270 may receive data from the server 230 for storage thereof and may provide stored data to the server 230 for use thereof.

In one or more implementations, the database 270 is configured to store, for each given web resource associated with a given entity: (i) listings of a plurality of items; (ii) transaction history of a plurality of users; (iii) customer feedback; (iv) inventory data of the plurality of items; (v) user account information of the plurality of users; (vi) user behavior data including past user behavior data and inferred user behavior data (vii) promotional activity including ongoing and past marketing, general and personalized offers; (viii) shipping information; and (ix) payment systems data.

In one or more implementations, the database 270 is configured to store, for each given web resource 255, one or more of (i) graphical user interface (GUI) design elements (layout, color schemes, fonts, styles); (ii) page templates (e.g., HTML/CSS template for different pages of the given web resource 255); (iii) accessibility features; (iv) navigation structure (e.g., menu system, site map, navigational aids); (v) media files; (vii) scripting and functionality (e.g. data about client-side and server-side scripts that enhance site functionality); and (viii) performance metrics.

In one or more implementations, the database 270 is configured to store: (i) personalized offer strategies of one or more entities; (ii) inference engine data (e.g., model parameters and hyperparameters, objective functions, training data, inputs, outputs, past predictions); (iii) personalized recommendation engine data (e.g., model parameters and hyperparameters, objective functions, training data, inputs, outputs, past predictions); and (iv) performance metrics relating to the inference and the personalized recommendation engine.

In one or more implementation, the database 270 is configured to store: (i) generated personalized recommendations per user, including items, unique identifiers (IDs), specific time periods, and timestamps.

In one or more implementations, the database 270 may store ML file formats, such as .tfrecords, .csv, .npy, and .petastorm as well as the file formats used to store models, such as .pb and .pkl. The database 270 may also store well-known file formats such as, but not limited to image file formats (e.g., .png, jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

### Communication Network

In one or more implementations of the present technology, the communications network 280 is the Internet. In one or more alternative non-limiting implementations, the communication network 280 may be implemented as any suitable local area network (LAN), wide area network (WAN), a private communication network or the like. It will be appreciated that implementations for the communication network 280 are for illustration purposes only. How a communication link 285 (not separately numbered) between the plurality of client devices 210, the server 230, the database 270, and/or another computing device (not shown) and the communications network 280 is implemented will depend inter alia on how each computing device is implemented.

The communication network 280 may be used in order to transmit data packets amongst the client devices 210, the server 230, the entity client devices 260 and the database 270. For example, the communication network 280 may be used to transmit requests from the web resource 255 to the server 230. In another example, the communication network 280 may be used to transmit data from the server 230 to the plurality of client devices 210.

### Inference Procedure

With reference to FIG. 3, there is shown a schematic diagram of inputs and outputs of an inference procedure 400 and the real-time personalized item recommendation procedure 500 in accordance with one or more non-limiting implementations of the present technology.

In one or more implementations of the present technology, the server 230 executes the inference procedure 300. In alternative implementations, the server 230 may execute at least a portion of the inference procedure 300, and one or more other servers (not shown) may execute other portions of the inference procedure 300.

### Data Acquisition Procedure

The data acquisition procedure 340 is configured to receive retailer data 310 with regard to a plurality of items associated with the given entity 206.

The entity or retailer data 310 may be received from entity client device(s) 260, from database 270 or from other computing devices (not shown).

The plurality of items corresponds to products, services, or content offered on the given web resource 255 by the given entity 206.

The web resource 255 associated with the given entity includes a graphical user interface (GUI) which enables, among other things, to view and purchase a plurality of items. The plurality of items may include products and/or services offered by the given entity. The type and number of items offered is not limited and may depend on the given entity.

In one or more implementations, a given item of the plurality of items is associated with one or more of: a item title, an item identifier, a description, a price, a promotion (including planned promotions and prior promotions), costs, demographics, preferences, competitive data, navigation data, one or more images, a SKU, an availability, an item category, a brand, customer reviews, customer ratings, dimensions and weight, shipping information, warranty information, related items and product tags.

In one or more implementations, the retailer data 310 may be stored by the server 230 in the database 270. In one or more other implementations, the retailer data may be accessible using an application programming interface (API) provided by the given entity.

### User Behavior Data

The data acquisition procedure 340 is configured to receive user behavior data 314 indicative of a respective behavior of a plurality of users, the user behavior data 314 comprising respective user profiles, respective user preferences, and respective past user interactions with a first set of items.

The plurality of users are users of the web resource associated with the given entity. As a non-limiting example, the plurality of users may correspond to the users of the plurality of client devices 210.

The user behavior data 314 indicative of a respective behavior of a plurality of users may be received from the given entity client device 260. In one or more other implementations, the user behavior data 314 indicative of a respective behavior of a plurality of users may be received from other sources. It should be noted that user behavior data 314 may include past behavior on the web resource 255 associated with the given entity and/or past behavior on other web resources, which may not be directly related to the plurality of items offered on the given web resource 255.

In one or more implementations, the respective user profiles of the plurality of users may include account details such as one or more of: username, real name, customer unique identifier, demographic data (e.g., age, gender, location, occupation, education), contact information (e-mail, phone, mailing address), interests and hobbies, account creation data, device information (e.g., type of device, OS type, browser), temporal data (time and data time stamps of user interactions).

In one or more implementations, the respective user preferences may include one or more of preferred product categories, brand preferences, size and fit, price range, color preferences, communication preferences, shipping preferences, language preferences, promotional preferences, and personalization settings.

The respective user interactions in the user behavior data 314 may include one or more of: pages visited, items clicked, search queries submitted, time spent on specific content, frequency of visits, item purchase history, returns, items added to or removed from a shopping cart, participation in promotions, responses to surveys, feedback provided on products or services, social media interactions related to the web resource, video or multimedia content engagement, downloads of brochures, white papers, or other documents, subscription to newsletters or other communications, account creation and updating of user profiles, abandonment rates of shopping carts or forms, click-through rates on targeted advertisements, sharing of content via social networks, return visits to previously viewed content, and use of interactive tools such as price calculators or product customization features.

In some implementations, the user behavior data 314 may be processed to remove sensitive data for compliance with regulatory requirements (e.g. GDPR). In one or more other implementations, the user behavior data 314 may be already devoid from sensitive data.

The user behavior data 312 includes respective past user interactions from each of the plurality of users with a first set of items. The first set of items may include at least a portion of the plurality of items on the given web resource 255. In one or more other implementations, the first set of items may include items different from the plurality of items on the given web resource 255, but from which inferences may be made with regard to the plurality of items on the given web resource 255. As a non-limiting example, the user behavior data 312 may be with respect to items no longer provided on the given web resource 255, or other items.

### Personalized Offer Strategies

In one or more implementations, the data acquisition procedure 340 receives, from the given entity 206 associated with at least one web resource 255, a set of personalized offer strategies 322 for a second set of items, the set of personalized offer strategies comprising a set of targeted users for each of the second set of items, and a set of pricing constraints for each of the second set of items.

The set of personalized offer strategies 322 comprises one or more offer strategies.

The personalized offer strategies 322 may be received from a computing device associated with each entity, such as the entity client device 260 associated with given entity 206.

It will be appreciated that there may be one or more personalized offer strategies 322 for each given entity 206. The personalized offers strategies 322 may be provided for different types of items, for different users and/or different periods of time.

The second set of items represents items provided by the given entity that the given entity 206 wants to recommend to one or more users of the plurality of user(s) of the web resource 255. In one or more implementations, the second set of items may correspond to the plurality of items provided on the given web resource 255 by the given entity 206. In one or more other implementations, the second set of items may be a subset of the plurality of items provided on the given web resource 255 by the given entity 206.

As a non-limiting example, the second set of items may be items from the plurality of items selected by the given entity 206 based on one or more of product title, a description, a price, a promotion (including planned promotions and prior promotions), costs, demographics, preferences, competitive data, navigation data, one or more images, a SKU, an availability, an item category, a brand, customer reviews, customer ratings, dimensions and weight, shipping information, warranty information, related items and product tags.

### Targeted Users

In one or more implementations, the personalized offer strategies includes an indication of a set of targeted users. The set of targeted users corresponds to users of the given web resource 255 for which the given entity wants to provide personalized offers with the second set of items.

In one or more implementations, the set of targeted users may correspond to all users registered on the given web resource 255. In one or more implementations, the set of targeted users corresponds to a subset of the users registered on the given web resource 255.

As a non-limiting example, the given entity may want to target loyal users, new users, cart abandoners, seasonal shoppers, high-value customers, geographically located users, demographic-specific users, interested-based targets, or event triggered (e.g., birthday, anniversary, holiday, personal milestones, etc.).

The set of targeted users may be selected based on user behavior data, such as one or more of user profile information (e.g., demographic info, age, loyalty status), user preferences (e.g., product categories, brands, shipping, color, language, etc.), past user interaction information (e.g., past purchased items, past saved items, spent amount over a period of time) and the like. As a non-limiting example, the set of targeted users may include the first user 202 shown in FIG. 2 and a plurality of other users, but not the second user 204.

### Additional User Interaction Information

In one or more implementations, the data acquisition procedure 340 receives from one or more third party sources (not shown), additional user behavior data 318. It should be noted that the additional user interaction information may be optional and is not necessarily required in each and every implementation of the present technology.

As a non-limiting example, the additional user behavior data 318 may include information representing or having been inferred from social media accounts from users, such as social interactions (e.g., likes, dislikes, reposts, upvotes, downvotes, shares, sentiment of comments, etc.), network data (information about friends, followers or groups), posted content (e.g., text, images, videos, etc.), engagement patterns (e.g., frequency and timing of posts, activity periods, engagement rate, etc.), and interest indicators (e.g., pages followed, hashtags, topics, etc.)

### Inference Engine

The inference procedure 400 is configured to inter alia: (i) execute one or more inference engines 242; (ii) receive retailer data 310; (iii) receive user behavior data 314; (iv) optionally receive additional user behavior data 318; (v) infer, using the one or more inference engines 242, inferred user behavior data 352.

The user behavior data 314 of the plurality of users is generally received in raw form from the given resource 255 associated with the given entity 206.

In one or more implementations, the past purchasing behavior and/or past navigation behaviour may be past behavior on a resource other than web resource 255. As a non-limiting example, it may be another web resource associated with the given entity 206 than the given resource for which implementations of the present technology are executed, e.g., past purchasing behavior and navigation behavior of users on a furniture store associated with the given entity, while the present technology may be executed for a grocery store associated with the given entity 206.

The one or more inference engines 242 are configured to identify patterns or correlations from historical data to make predictions about future behaviors.

In one or more implementations, the one or more inference engines 242 may implement one or more analytical models or having been specifically trained to perform inference of user behavior.

In one or more implementations, the one or more inference engines 242 may use one or more of: large language models (LLMs), linear regression models, logistic regression models, Poisson models, negative binomial models, clustering algorithms (e.g., K-means, Gaussian mixture models), and econometric time series. The one or more inference engines 242 may be trained on training data to update their respective model parameters. The inference engine model parameters may be stored in the database 270 or another storage medium (not shown).

The one or more inference engines 242 may be configured to predict one or more of: (i) the probability that a user will purchase a specific item or a set of items based on their past buying habits, browsing history, and engagement with similar items; (ii) which users are likely to stop using or significantly reduce interactions with the web resource 255 by analyzing patterns such as decreasing engagement, fewer logins, or reduced purchasing frequency; (iii) user segmentation by classifying users into different segments based on their behavior, preferences, and demographic information to tailor marketing strategies; (iv) the most appropriate item or service to offer next, increasing the personalization of recommendations; (v) when a user is likely to make their next purchase of an item; (vi) how sensitive a user is to price changes of items based on their reaction to past pricing strategies; (vii) user responses to specific marketing campaigns of the web resource 255; (viii) levels of user engagement, such as the likelihood of participating in surveys or writing reviews, enhancing both user satisfaction and business outcomes with the web resource 255; and (ix) infer user preferences with regard to items.

In one or more implementations, the one or more inference engines 242 perform inferences for each given user of the plurality of users of the web resource 255. In such implementations, the inference procedure 400 may generate a specific user behavior profile for each user such that upon receiving user interactions from a given user in real-time, the real-time personalized item recommendation procedure 500 may generate real-time personalized recommendations of items for each user.

As a non-limiting example, the inference procedure 400 use the one or more inference engines 242 to predict that a user is likely to buy a new type of athletic shoe if they have searched for similar products frequently.

In one or more implementations, the inference procedure 400 implements a feedback loop to further refine and train the model upon receiving outcomes of the predictions (e.g., whether the given user actually purchased the personalized recommended items) received from the real-time personalized item recommendation procedure 500.

The inference procedure 400 stores inferred user behavior data 352 for use by the real-time personalized item recommendation procedure 500. In one or more implementations, inference procedure 400 stores the inferred user behavior data 352 in a non-transitory storage medium including the database 270.

### Real-Time Personalized Item Recommendation Procedure

The real-time personalized item recommendation procedure 500 is configured to generate, in real-time, using the one or more personalized recommendation engines 246, based on a real-time user interaction performed by a client device 210, 212, the inferred user behavior data and the set of personalized offer strategies and the objective function, a set of targeted items for a given user registered with the resource.

In one or more implementations, the one or more personalized recommendation engines 246 may include one or more of: neural networks, Kolmogorov-Arnold networks, regression trees (e.g., gradient-boosted trees models), recommender systems, Markov processes, Monte Carlo simulations, and double debiased machine learning models.

The real-time personalized item recommendation procedure 500 is configured to inter alia: (i) receive retailer data 310; (ii) receive a set of personalized offer strategies 322; (iii) receive one or more objective functions 326; (iv) optionally receive 3^{rd} party data 332; (v) receive, in real-time, a user interaction 412 performed by a client device 210, 212 on the web resource 255; (v) generate, in real-time, based on the user interaction 412, the retailer data 310, the set of personalized offer strategies 322, the 3^{rd} party data, 332 a set of personalized recommendations for the given user 202, 204, the set of personalized recommendations comprising a second set of items.

The real-time personalized item recommendation procedure 500 is configured to receive the real-time user interaction 412.

The type of real-time user interaction 412 is not limited and may depend on implementations of the present technology. In one or more implementations, the real-time personalized item recommendation procedure 500 may only be triggered by a predetermined type of user interactions. In some implementations, the real-time user interaction 412 triggering the real-time personalized item recommendation procedure 500 may depend on the profile and inferred user behavior data 352 of the respective user 202, 204.

In one or more implementations, the real-time user interaction 412 is received from the client device 210, 210 of the respective user 202, 204. As a non-limiting example, the real-time user interaction 412 may be the user viewing a page, adding a given item to his cart, a user hovering over an item listed on the web page, a user dwell time on the page being above a threshold, and the like. In one or more other implementations, the real-time user interaction 412 is received from the given web resource 255.

In one or more alternative implementations, the receiving of the real-time user interaction 412 may be triggered by one or more of the following: a number of clicks, a click-through rate (CTR), a dwell time, a click depth, a bounce rate, and an average time spent on the web resource.

The one or more personalized recommendations engines 244 are configured to receive the objective function associated with the given entity 206. It will be appreciated that the objective function 326 may be received at any time before the user interaction 412.

In one or more implementations, each given entity 206 is associated with at least one objective function 326. In one or more alternative implementations, each personalized offer strategy of the set of personalized offer strategies 322 is associated with a respective objective function of the set of objective functions 326.

In one or more implementations, the objective function 326 associated with the entity is a retailer objective function. A retailer's objective function refers to the goal or objective that a given entity 206 aims to maximize or minimize in order to optimize their operations. The objective function 326 is a mathematical representation of the retailer's objectives, often used in decision-making and optimization models.

The specific objective function 326 can vary depending on the goals and priorities of the given entity 206. Non-limiting examples of metrics in an objective function 326 may include one or more of: maximizing profit, maximizing sales, maximizing volume, maximizing market share, minimizing costs, or maximizing customer satisfaction. It will be appreciated that objective function 326 may include a weighted combination of the example metrics (e.g., max sales and max profits).

The one or more personalized recommendations engines 244 are configured to optimize the objective function 326 associated with the given entity 206.

In one or more implementations, the objective function 326 may be associated with a given personalized strategy 322 received from the given entity 206.

The one or more offer engines 246 are configured to, based on the inferred user behavior data 352, the personalized offer strategies 322 associated with the given entity 206, the objective function 326 associated with the given entity, 206 and optionally third party data 332: (i) perform item inclusion and item exclusion to determine a second set of items from the plurality of items on the given web resource 255; (ii) determine a set of targeted users from the plurality of users of the web resource 255; (iii) determine personalized item recommendations with items and respective discounts for a given user; (iv) determine constraints (i.e., limiting conditions) for the second set of items including the set of targeted items; (v) determine and solve conflicts between personalized offer strategies 322; and (vi) optionally solve any other conflicts in the input data.

In one or more implementations, a personalized item recommendations include one or more items associated with an adjusted price (i.e., reduced price or percentage of discount) and rewards (e.g., gifts, points, future discounts, etc.).

Conflicts between the set of personalized offer strategies may arise at one or more of: the user level, at the product level and at the recommendation level.

As a first non-limiting example, a user of the plurality of users may fall in two different personalized offer strategies (each having specific types of targeted users), where a first personalized offer strategy may state the targeted user should be provided with two recommendations while a second offer strategy may state the targeted user should be provided with three recommendations. In such instances, the conflict may be solved by the one or more personalized recommendation engine prior to receiving a real-time user interaction or in response to receiving the real-time user interaction.

As second non-limiting example, two different personalized offer strategies may include the same item, where the first personalized offer strategy may include a discount of 20% while a second personalized offer strategy may include a discount of 30%. In such instances, the conflict may be solved by the one or more personalized recommendation engines 244 prior to receiving a real-time user interaction or in response to receiving the real-time user interaction.

As a third non-limiting example, a given item may be already under a promotion, and the one or more personalized recommendation engines 244 may solve the conflict such that a personalized recommendation with a discount is not performed in the same session for the given item.

In one or more implementations, the constraints or limiting conditions may include one or more of: number of item recommendations per customer, minimum margin, minimum and maximum discounts, discount increments, price rounding rules, minimum number of days before a new product is promoted, investment budget, and the like.

In one or more implementations, the personalized item recommendations includes stackable items discounts, where multiple discounts are applied to an item in a cumulative manner. This allows for the combination of different types of discounts, such as percentage-off, fixed amount off, or special member discounts, to maximize savings. It will be appreciated that stackable item discounts incentivize larger item consumption and repeated item consumption but also enables users to feel they are receiving maximum value, thus enhancing user satisfaction and loyalty on the given web resource 255. A non-limiting example of a stackable item discounts is a mass offer of 20% and then a personalized offer on top of that 20% for an additional 10%, such that the user obtains a total discount of 30%. It will be appreciated that in other implementations, if the given entity 206 does not want stackable item discounts, the one or more offer engines may be configured to not provide personalized recommendations on already-discounted items.

The one or more personalized recommendation engine 244 may be configured to generate personalized item recommendations for a given user that may include one or more of: (i) complementary item bundling, by identifying items that are frequently bought together (e.g., laptops with laptop cases and wireless mice); (ii) seasonal or thematic bundling, creating bundles based on the season or upcoming events (e.g., back-to-school supplies or Christmas decorations); (iii) user behavior-based bundling, tailoring bundles to the user's specific interests or needs (e.g., fantasy novels and related merchandise for a frequent buyer of that genre); (iv) price sensitivity bundling, offering bundles that match a user's spending habits (e.g., value-focused bundles for price-sensitive users or premium products for those preferring high-end items); (v) inventory and sales-driven bundling, targeting items that need to be moved efficiently (e.g., bundling overstocked or end-of-life products with popular items); a (vi) lifestyle or demographic-based bundling, using demographic information to cater to specific groups (e.g., fitness enthusiasts receiving bundles of health supplements, workout gear, and fitness trackers); (vii) matching items based on aesthetic style; (viii) upselling a user to higher premium versions of items; and (ix) switching users to substitutable versions of items that meet the same user needs and preferences.

It will be appreciated that the one or more personalized recommendation engines 244 are configured to generate the personalized item recommendation based on the real-time user interaction 412, the personalized offer strategies 322, the objective function 326, and the inferred user behavior data 352. In one or more implementations, the personalized recommendation engines 244 are implemented as offers engines.

In one or more implementations, the one or more personalized recommendation engines 244 are pretrained based on the personalized offer strategies 322, the objective function 326, and the inferred user behavior data 352. In such implementations, the server 230 may store model parameters of the personalized recommendation engine 244 which have been trained on the retailer data 310 personalized offer strategies 322, the objective function 326, and the inferred user behavior data 352 for each instance thereof.

Then, upon receiving a real-time user interaction 412 from a given user of the web resource 255, the one or more personalized recommendation engine 244 are configured to generate personalized item recommendations.

The personalized item recommendation is valid for a specific time period. It will be appreciated that the time period may be predetermined by operators of the present technology, based on the personalized offer strategies 322, and/or determined in real-time based on the inferred user behavior data 352.

The personalized item recommendation is associated with a personalized respective identifier or code. The personalized code is specifically assigned or generated for an individual user for which the personalized item recommendation is made, i.e., the user 202 of the client device 212. This personalized code is unique to that particular user and can be used to avail discounts, special offers, or other incentives on the given resource 255 during the time period. In one or more other implementations, the personalized unique code serves as a digital token that is automatically applied and/or that the user can enter during the checkout process to apply the associated discount or promotional offer to their purchase. The personalized code is also provided to the given entity 206 for tracking purposes. This approach allows the server 230 and the given entity 206 to track and target specific users with customized promotions, enhancing the user experience and encouraging repeat visits or purchases. It will be appreciated that the personalized unique code enables the given user to access the personalized offer before the expiry of the specific period of time. In one or more implementations, the specific period of time may be determined by the one or more personalized recommendations engines 244 and may be unique to the given user for which the personalized item recommendation is generated.

In one or more implementations, an indication of the personalized item recommendation is stored, for example in a non-transitory storage medium such as the cache or in the database 270. Upon expiry of the specific time period, the personalized item recommendation may not be available to the user 202, however it may be stored for improving the real-time personalized item recommendation procedure 500 and the one or more personalized recommendation engines 244.

In one or more implementations, the real-time personalized item recommendation procedure 500 is configured to perform application caching, for each request of a user to retrieve personalized item recommendations retrieve a list from the database 270 and cache in-memory to speed up responses and avoid unnecessary database calls, thereby easing application architecture.

The real-time personalized item recommendation procedure 500 is configured to execute the one or more cache engines 248 to cache the response's payload when a given user request their personalized offers for the first time. The subsequent requests return this cached data instead of re-processing every rule in the back end again. The real-time personalized item recommendation procedure 500 causes invalidation of the cache whenever a personalized offer is used or new/different offers are generated for the same user, requiring the next back-end request to run the process from the beginning.

In some implementations, caching is performed by storing data in the RAM, allowing for fast read and write operations compared to disk-based databases. As a non-limiting example, reading from and writing to the cache is performed using the GET and SET commands.

When the real-time personalized item recommendation procedure 500 requires data, it first verifies the cache using the one or more cache engines 248. If the data is present (cache hit), the cache engine returns it from memory. If not (cache miss), the cache engine fetches the data from the primary database (e.g. database 270) and stores it in the cache for subsequent requests.

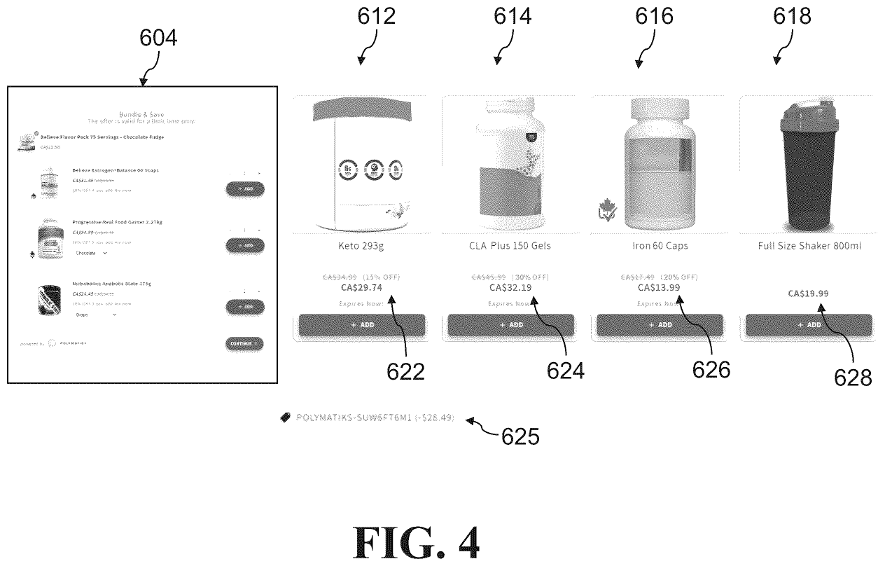

FIG. 4 illustrates a non-limiting example of personalized item recommendations 604 shown to a user having performed a user interaction on a web resource. The personalized item recommendations 604 include a first personalized recommended item 612 with adjusted price 622, a second personalized recommended item 614 with adjusted price 624, a third personalized recommended item 616 with adjusted price 626 and a fourth personalized recommended item 618 with regular price 628 (but without a discount), which are part of a bundle in the personalized item recommendations 604.

The personalized code 625 associated with the personalized item recommendations is shown at the bottom of the interface elements, with the total amount saved in parentheses.

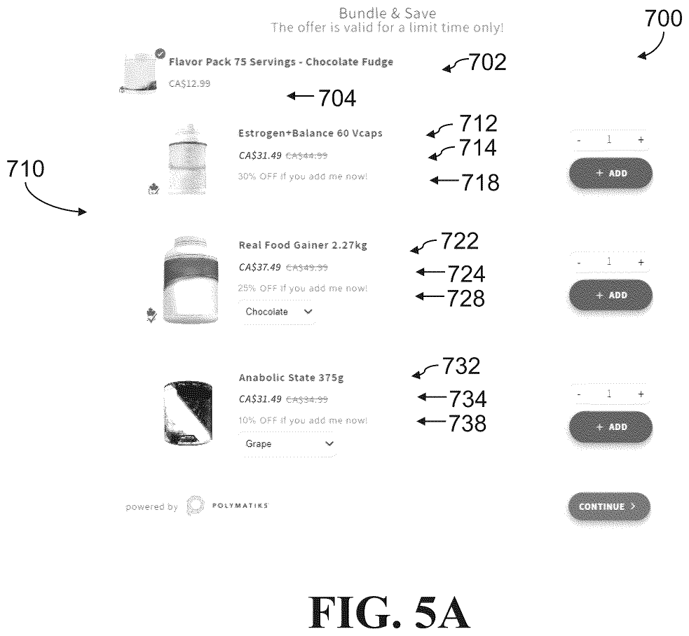

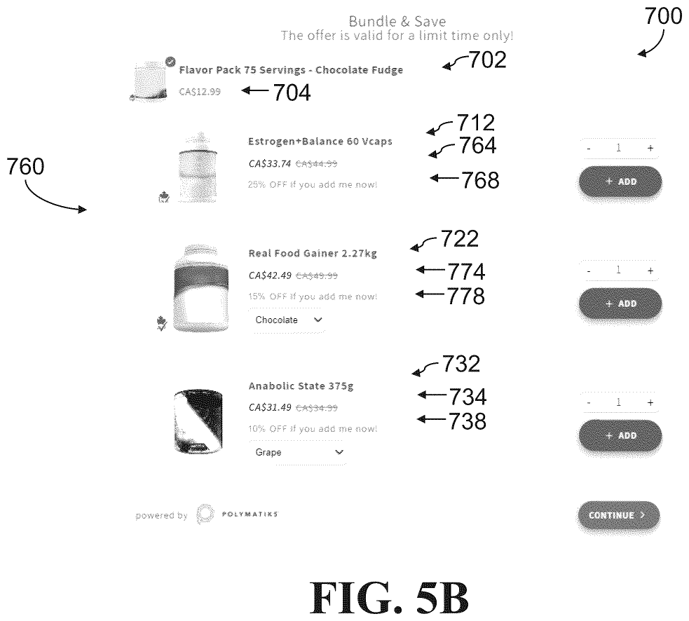

FIG. 5A shows another non-limiting example of personalized item recommendations 710 in a user interface 700 provided to a first user. The item 702 has been added to a cart of the user on the resource, with the regular price shown 704 under a title of the item 702. The personalized item recommendation 710 include a first personalized recommended item 712, a second personalized recommended item 722, and a third personalized recommended item 732. The first personalized recommended item 712 shows an adjusted price 714 with the mention 716 “25% OFF if you add me now” and the second personalized recommended item 722, shows adjusted price 724 with the mention 726 “15% OFF if you add me now”, and the third personalized recommended item 732 shows an adjusted price 734 with the mention 736 “10% OFF if you add me now”.

FIG. 5B shows a similar personalized item recommendation 760 in a user interface 700 provided to a second user. The personalized item recommendation 760 is similar to the personalized item recommendation 710 with the first personalized recommended item 712, the second personalized recommended item 722, and the third personalized recommended item 732, however the first personalized recommended item 712 is associated with a different first adjusted price 764 and mention 768 “25% OFF if you add me now”, the second personalized recommended item 722 is associated with a different second adjusted price 774 and mention 778 “15% OFF if you add me now”, and the third personalized recommended item 732 is associated with the same third adjusted price 734 with the mention 736 “10% OFF if you add me now”.

It will be appreciated that the personalized item recommendations with different discounts (i.e., adjusted prices) have been provided by the real-time personalized item recommendation procedure 500 due to differences in past user interactions between the first user and the second user, for example the first user may be a more loyal customer or may be more sensitive to price fluctuations than the second user.

It should be noted that the personalized item recommendations 710 and 760 are related to the item 702 are part of the same category, i.e., sport nutrition supplements, which have been generated by using implementations of the real-time personalized item recommendation procedure 500.

### Method Description

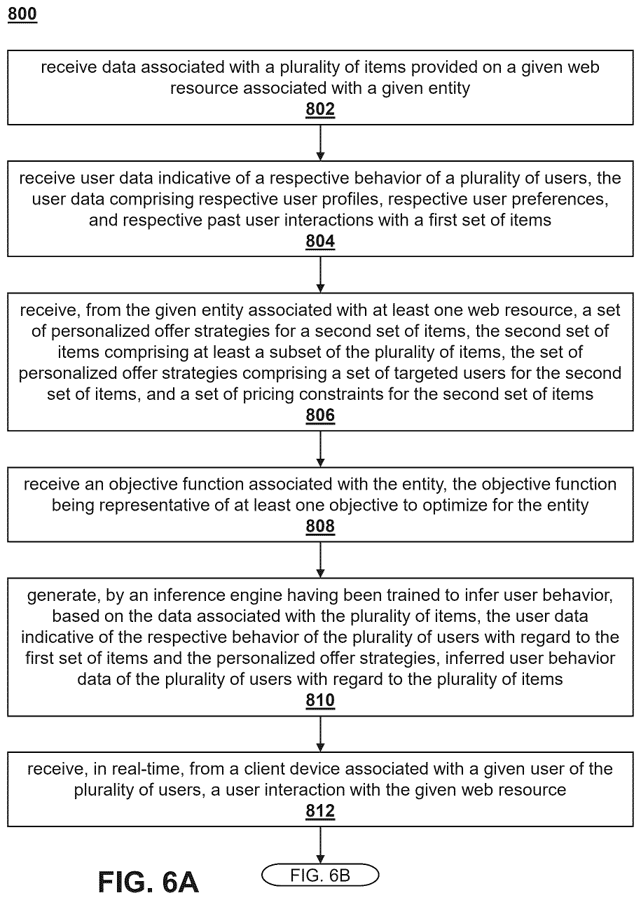

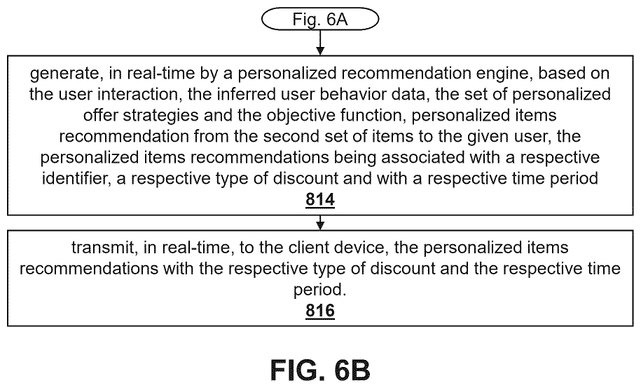

FIG. 6 depicts a flowchart of a method 800 of providing personalized recommendations to a user in real-time in accordance with one or more non-limiting implementations of the present technology.

In one or more implementations, the server 230 comprises at least one processor such as the processor 110 and/or the GPU 111 operatively connected to a non-transitory computer readable storage medium such as the solid-state drive 120 and/or the random-access memory 130 storing computer-readable instructions. The processing device upon executing the computer-readable instructions, is configured to or operable to execute the method 800.

The method 800 begins at processing step 802.

At processing step 802, the at least one processor receives data associated with a plurality of items provided on a given web resource associated with a given entity.

In one or more implementations, a given item of the plurality of items is associated with one or more of: an item title, an item identifier, a description, a price, a promotion (including planned promotions and prior promotions), costs, demographics, preferences, competitive data, navigation data, one or more images, a SKU, an availability, an item category, a brand, customer reviews, customer ratings, dimensions and weight, shipping information, warranty information, related items and product tags.

At processing step 804, the at least one processor receives user data indicative of a respective behavior of a plurality of users, the user data comprising respective user profiles, respective user preferences, and respective past user interactions with a first set of items.

In one or more implementations, the respective user profiles of the plurality of users may include account details such as one or more of: username, real name, customer unique identifier, demographic data (e.g., age, gender, location, occupation, education), contact information (e-mail, phone, mailing address), interests and hobbies, account creation data, device information (e.g., type of device, OS type, browser), temporal data (time and data time stamps of user interactions).

The user behavior data 314 indicative of a respective behavior of a plurality of users may be received from the given entity client device 260. In one or more other implementations, the user behavior data 314 indicative of a respective behavior of a plurality of users may be received from other sources. It should be noted that user behavior data 314 may include past behavior on the web resource 255 associated with the given entity and/or past behavior on other web resources, which may not be directly related to the plurality of items offered on the given web resource 255.

The respective user interactions in the user behavior data 314 may include one or more of: pages visited, items clicked, search queries submitted, time spent on specific content, frequency of visits, item purchase history, returns, items added to or removed from a shopping cart, participation in promotions, responses to surveys, feedback provided on products or services, social media interactions related to the web resource, video or multimedia content engagement, downloads of brochures, white papers, or other documents, subscription to newsletters or other communications, account creation and updating of user profiles, abandonment rates of shopping carts or forms, click-through rates on targeted advertisements, sharing of content via social networks, return visits to previously viewed content, and use of interactive tools such as price calculators or product customization features.

The user behavior data 312 includes respective past user interactions from each of the plurality of users with a first set of items. The first set of items may include at least a portion of the plurality of items on the given web resource 255. In one or more other implementations, the first set of items may include items different from the plurality of items on the given web resource 255, but from which inferences may be made with regard to the plurality of items on the given web resource 255. As a non-limiting example, the user behavior data 312 may be with respect to items no longer provided on the given web resource 255, or other items.

At processing step 806, the at least one processor receives, from the given entity associated with at least one web resource, a set of personalized offer strategies for a second set of items, the second set of items comprising at least a subset of the plurality of items, the set of personalized offer strategies comprising a set of targeted users for the second set of items, and a set of pricing constraints for the second set of items

At processing step 808, the at least one processor receives an objective function associated with the entity, the objective function being representative of at least one objective to optimize for the entity.

The objective function 326 is a mathematical representation of the retailer's objectives, often used in decision-making and optimization models. The specific objective function 326 can vary depending on the goals and priorities of the given entity 206. Non-limiting examples of metrics in an objective function 326 may include one or more of: maximizing profit, maximizing sales, maximizing volume, maximizing market share, minimizing costs, or maximizing customer satisfaction. It will be appreciated that objective function 326 may include a weighted combination of the example metrics (e.g., max sales and max profits).

At processing step 810, the at least one processor generates, by using an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items.

In one or more implementations, the one or more inference engines 242 may use one or more of: large language models (LLMs), linear regression models, logistic regression models, Poisson models, negative binomial models, clustering algorithms (e.g., K-means, Gaussian mixture models), and econometric time series. The one or more inference engines 242 may be trained on training data to update their respective model parameters. The inference engine model parameters may be stored in the database 270 or another storage medium (not shown).

The one or more inference engines 242 may be configured to predict one or more of: (i) the probability that a user will purchase a specific item or a category of items based on their past buying habits, browsing history, and engagement with similar items; (ii) which users are likely to stop using or significantly reduce interactions with the web resource 255 by analyzing patterns such as decreasing engagement, fewer logins, or reduced purchasing frequency; (iii) user segmentation by classifying users into different segments based on their behavior, preferences, and demographic information to tailor marketing strategies; (iv) the most appropriate item or service to offer next, increasing the personalization of recommendations; (v) when a user is likely to make their next purchase of an item; (vi) how sensitive a user is to price changes of items based on their reaction to past pricing strategies; (vii) user responses to specific marketing campaigns of the web resource 255; (viii) levels of user engagement, such as the likelihood of participating in surveys or writing reviews, enhancing both user satisfaction and business outcomes with the web resource 255; and (ix) infer user preferences with regard to items.

Processing step 802 to 810 may be executed at any time and offline before executing processing steps 812 to 816.

At processing step 812, the at least one processor receives, in real-time, from a client device associated with a given user of the plurality of users, a user interaction with the given web resource.

In one or more implementations, the real-time user interaction 412 is received from the client device 210, 210 of the respective user 202, 204. As a non-limiting example, the real-time user interaction 412 may be the user viewing a page, adding a given item to his cart, a user hovering over an item listed on the web page, a user dwell time on the page being above a threshold, and the like. In one or more other implementations, the real-time user interaction 412 is received from the given web resource 255.

In one or more alternative implementations, the receiving of the real-time user interaction 412 may be triggered by one or more of the following: pages visited, items clicked, search queries submitted, time spent on specific content, a number of clicks, a click-through rate (CTR), a dwell time, a click depth, a bounce rate, and an average time spent on the web resource.

In some implementations, the at least one processor may receive all types of real-time user interactions performed by the given user on the web resource 255. It will be appreciated that in alternative implementations, the at least one processor may receive the real-time user interaction from the given web resource 255 only if a criterion is met (e.g., threshold).

In one or more implementations, the at least one processor verifies if the given user has previously registered on the given web resource 255. If the user has previously registered with an account, the at least one processor proceeds to processing step 814. If the user has not previously registered with an account, the method 800 may end.

At processing step 814, the at least one processor generates, in real-time by an personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period.

In one or more implementations, the one or more personalized recommendation engines 244 are pretrained based on the personalized offer strategies 322, the objective function 326, and the inferred user behavior data 352. In such implementations, the server 230 may store model parameters of the personalized recommendation engine 244 which have been trained on the retailer data 310 personalized offer strategies 322, the objective function 326, and the inferred user behavior data 352 for each instance thereof. In such implementations, the at least one processor may execute the one or more personalized recommendation engine 244 and provide as an input the real-time user interaction with an identifier of the given user, which enables the one or more personalized recommendations engines 244 to generate the personalized item recommendations.

The one or more offer engines 246 are configured to, based on the inferred user behavior data 352, the personalized offer strategies 322 associated with the given entity 206, the objective function 326 associated with the given entity, 206 and optionally third party data 332: (i) perform item inclusion and item exclusion to determine a second set of items from the plurality of items on the given web resource 255; (ii) determine a set of targeted users from the plurality of users of the web resource 255; (iii) determine a set or targeted items (personalized item recommendations) and respective discounts for a given user; (iv) determine constraints (i.e., limiting conditions) for the second set of items including the set of targeted items; (v) determine and solve conflicts between personalized offer strategies 322; and (vi) optionally solve any other conflicts in the input data.

At processing step 816, the at least one processor transmits, in real-time, to the client device, the personalized item recommendations with the respective type of discount and the respective time period. In one or more implementations, the transmission may cause display of the personalized item recommendations with item title, description, custom text, adjusted price, rewards, identifier and time period during which it is valid.

In one or more implementations, the at least one processor caches, in a non-transitory storage medium operatively connected to the at least one processor, the personalized item recommendation associated with the respective identifier, the respective type of discount and the respective time period.

In one or more implementations, the at least one processor receives a further user interaction, the further user interaction comprising an indication of the respective identifier of the personalized item recommendation. As another non-limiting example, the further user interaction may be the user adding the personalized item recommendations to a cart on the web resource for a checkout.

In one or more implementations, the at least one processor receives, from the non-transitory storage medium, based on the further user interaction, the cached personalized item recommendation. The at least one processor is configured to use the one or more cache engines 238 to perform caching.

In one or more implementations, the at least one processor compares the respective time period of the cached personalized item recommendation to a time difference between the user interaction and the further user interaction.

In response to the time difference being less than the respective time period: the at least one processor provides a confirmation of the personalized item recommendation to the client device.

In such implementations, the user may perform purchase of the personalized item recommendation with the adjusted price.

In response to the time difference being less than the respective time period: the at least one processor provides a denial of the personalized item recommendation to the client device. As a non-limiting example, the at least one processor may cause display of a text stating that the personalized item recommendation has expired.

In one or more implementations, the at least one processor tracks the user interactions of the user having received the personalized item recommendations including redeemed recommendations, savings, and viewed offers for metrics and for providing feedback to and continuously training the one or more inference engines 242 and/or the one or more personalized recommendation engine 246.

The method 800 then ends.

It should be expressly understood that not all technical effects mentioned herein need to be enjoyed in each and every implementation of the present technology. For example, implementations of the present technology may be implemented without the user enjoying some of these technical effects, while other non-limiting implementations may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A method for providing personalized item recommendations to a given user in real-time, the method being executed by at least one processor, the method comprising:
receiving data associated with a plurality of items provided on a given web resource associated with a given entity;
receiving user data indicative of a respective behavior of a plurality of users, the user data comprising respective user profiles, respective user preferences, and respective past user interactions with a first set of items;
receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items;
receiving an objective function associated with the entity, the objective function being representative of at least one objective to optimize for the entity;
generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items;
receiving, in real-time, from a client device associated with a given user of the plurality of users, a user interaction with the given web resource;
generating, in real-time by a personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period; and
transmitting, in real-time, to the client device, the personalized items recommendations with the respective type of discount and the respective time period.

2. The method of claim 1, wherein the user interaction comprises at least one of: searching for a given item of the second set of items, viewing the given item and selecting the given item.

3. The method of claim 2, further comprising:
caching, in a non-transitory storage medium operatively connected to the at least one processor, the personalized item recommendations associated with the respective identifier, the respective type of discounts and the respective time periods;
receiving a further user interaction, the further user interaction comprising an indication of the respective identifier of the personalized item recommendations;
receiving, from the non-transitory storage medium, based on the further user interaction, the cached personalized item recommendations;
comparing the respective time period of the cached personalized item recommendation to a time difference between the user interaction and the further user interaction; and
in response to the time difference being less than the respective time period:
providing a confirmation of the personalized item recommendations to the client device.

4. The method of claim 3, wherein the respective past user interactions comprise at least one of: past purchased items and past viewed items.

5. The method of claim 4, wherein the personalized recommendation engine is configured to determine and solve conflicts between personalized offer strategies.

6. The method of claim 5, wherein the personalized item recommendations comprise at least one stackable item associated with an aggregated discount, the aggregated discount being a combination of two respective adjusted discounts.

7. The method of claim 6, wherein the respective type of discount for the personalized item recommendation comprises at least one of: an adjusted price and a reward.

8. The method of claim 1, further comprising:
receiving another user interaction, the user interaction confirming the personalized item recommendation; and
storing the user interactions, the personalized item recommendation and the respective type of discount for further training of the personalized recommendation engine.

9. The method of claim 1, wherein the personalized recommendation engine comprises at least one of: neural networks, Kolmogorov-Arnold networks, regression trees, recommender systems, Markov processes, Monte Carlo simulations, and double debiased machine learning models.

10. The method of claim 9, wherein the set of constraints comprise at least one of: number of item recommendations per user, minimum margin, minimum and maximum discounts, discount increments, price rounding rules, minimum number of days before a new item is promoted, investment and budget.

11. A system for providing personalized item recommendations to a given user in real-time, the system comprising:
a non-transitory storage medium storing computer-readable instructions thereon; and
at least one processor operatively connected to the non-transitory storage medium,
the system being operatively connected to a client device, the at least one processor, upon executing the computer-readable instructions, being configured for:
receiving data associated with a plurality of items provided on a given web resource associated with a given entity;
receiving user data indicative of a respective behavior of a plurality of users, the user data comprising respective user profiles, respective user preferences, and respective past user interactions with a first set of items;
receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items;
receiving an objective function associated with the entity, the objective function being representative of at least one objective to optimize for the entity;
generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items;
receiving, in real-time, from the client device associated with a given user of the plurality of users, a user interaction with the given web resource;
generating, in real-time by an personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period; and
transmitting, in real-time, to the client device, the personalized items recommendations with the respective type of discount and the respective time period.

12. The system of claim 11, wherein the user interaction comprises at least one of: searching for a given item of the second set of items, viewing the given item and selecting the given item.

13. The system of claim 12, wherein the at least one processor is further configured for:
caching, in a non-transitory storage medium operatively connected to the at least one processor, the personalized item recommendation associated with the respective identifier, the respective type of discount and the respective time period;
receiving a further user interaction, the further user interaction comprising an indication of the respective identifier of the personalized item recommendation;
receiving, from the non-transitory storage medium, based on the further user interaction, the cached personalized item recommendation;
comparing the respective time period of the cached personalized item recommendation to a time difference between the user interaction and the further user interaction; and
in response to the time difference being less than the respective time period:
providing a confirmation of the personalized item recommendation to the client device.

14. The system of claim 13, wherein the respective past user interactions comprise at least one of: past purchased items and past viewed items.

15. The system of claim 14, wherein the personalized recommendation engine is configured to determine and solve conflicts between personalized offer strategies.

16. The system of claim 15, wherein the personalized item recommendations comprise at least one stackable item associated with an aggregated discount, the aggregated discount being a combination of two respective adjusted discounts.

17. The system of claim 16, wherein the respective type of discount for the personalized item recommendation comprises at least one of: an adjusted price and a reward.

18. The system of claim 17, wherein the at least one processor is further configured for:
receiving another user interaction, the user interaction confirming the personalized item recommendation; and
storing the user interactions, the personalized item recommendation and the respective type of discount for further training of the personalized recommendation engine.

19. The system of claim 18, wherein the personalized recommendation engine comprises at least one of: neural networks, Kolmogorov-Arnold networks, regression trees, recommender systems, Markov processes, Monte Carlo simulations, and double debiased machine learning models.

20. A non-transitory storage medium storing computer-readable instructions thereon, the computer-readable instructions, upon being executed by at least one processor, are configured for causing:
receiving data associated with a plurality of items provided on a given web resource associated with a given entity;
receiving user data indicative of a respective behavior of a plurality of users, the user data comprising respective user profiles, respective user preferences, and respective past user interactions with a first set of items;
receiving, from the given entity associated with at least one web resource, a set of personalized offer strategies for a second set of items, the second set of items comprising at least a subset of the plurality of items, the set of personalized offer strategies comprising a set of targeted users for the second set of items, and a set of constraints for the second set of items;
receiving an objective function associated with the entity, the objective function being representative of at least one objective to optimize for the entity;
generating, by an inference engine having been trained to infer user behavior, based on the data associated with the plurality of items, the user data indicative of the respective behavior of the plurality of users with regard to the first set of items and the personalized offer strategies, inferred user behavior data of the plurality of users with regard to the plurality of items;
receiving, in real-time, from a client device associated with a given user of the plurality of users, a user interaction with the given web resource;
generating, in real-time by a personalized recommendation engine, based on the user interaction, the inferred user behavior data, the set of personalized offer strategies and the objective function, personalized items recommendation from the second set of items to the given user, the personalized items recommendations being associated with a respective identifier, a respective type of discount and with a respective time period; and
transmitting, in real-time, to the client device, the personalized items recommendations with the respective type of discount and the respective time period.
